(19) United States
(12) Patent Application Publication
(10) Pub. No.: US 2026/0012096 A1
(43) Pub. Date: Jan. 8, 2026

(54) DEVICE, METHOD AND SYSTEM FOR A POWER CONVERTER WITH A PARTIALLY SATURATED INDUCTOR

(71) Applicant: Betterfrost Technologies Inc., Oakville (CA)

(72) Inventors: Ahmed Sheir, Brampton (CA); Sameh M. I. Saad, Stoney Creek (CA); Eltaib Abdeen D. Ibrahim, Qus Center (EG)

(21) Appl. No.: 19/261,287

(22) Filed: Jul. 7, 2025

Related U.S. Application Data
(60) Provisional application No. 63/668,038, filed on Jul. 5, 2024.

(51) Int. Cl. H02M 3/158

(52) U.S. Cl. CPC H02M 3/1582

(57) ABSTRACT

Devices and methods are provided for a power convertor with a partially saturated inductor. A power converter with a partially saturated inductor includes an inductor sized to support an average current and a root mean square current. The inductor is further sized to lose a portion of inductance at a peak current as a result of entering a roll-off region, wherein the roll-off region is situated between a start of inductance saturation and a full inductance saturation. A method of designing a power converter with a partially saturated inductor includes sizing an inductor of the power converter to support an average current and a root mean square current. The method further includes sizing the inductor to lose a portion of inductance at a peak current as a result of entering a roll-off region, wherein the roll-off region is situated between a start of inductance saturation and a full inductance saturation.

### TECHNICAL FIELD

The embodiments disclosed herein relate to power converters, and, in particular to a power converter with a partially saturated inductor.

### INTRODUCTION

Advancements in semiconductor material and packaging have led to significant reductions in semiconductor power switches and improvements in their operating frequency and efficiency. Although a similar trend is observed in designing and manufacturing magnetic components (namely high frequency power inductors, and transformers), their respected size in any kilowatt range power converter printed circuit board (PCB) still imposes a bottleneck that holds any significant reduction towards achieving higher density designs.

One technique to reduce the size of a power inductor is to design the converter to operate at higher switching frequency. However, this has a negative impact on the overall converter efficiency and increases the design complexity.

Another technique to reduce the size of a power inductor is to split the inductor into multiple inductors in parallel, series, or interleaved configuration. However, this has the adverse effect of increasing the converter's overall size and weight.

Accordingly, there is a need for techniques to reduce the size of a power converter that are not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

A power converter with a partially saturated inductor is provided. The power converter includes an inductor. The inductor is sized to support an average current and a root mean square (RMS) current. The inductor is further sized to lose a portion of inductance at a peak current as a result of inherent soft saturation in soft saturated inductors or entering a roll-off region, wherein the roll-off region is situated between a start of inductance saturation and a full inductance saturation.

In an embodiment, the portion of inductance is about 30%.

In an embodiment, a modified peak current mode controller is used to control the power converter in a peak current control mode with soft saturated inductor, partially saturated inductor, or fully saturated inductor.

In an embodiment, the power converter is a non-isolated high density power converter.

In an embodiment, the power converter is any type of second order or fourth order DC-DC converter.

In an embodiment, the power converter is a closed loop boost converter.

In an embodiment, the inductor has an nominal (unsaturated) inductance of 100 uH.

In an embodiment, the inductor has a saturated inductance of 20 uH.

In an embodiment, inductance saturation begins at a saturated current of 20 A.

In an embodiment, the power converter operates in one of: a continuous conduction mode; a discontinuous conduction mode; and a boundary conduction mode.

A method of designing a power converter with a partially saturated inductor is provided. The method includes sizing an inductor of the power converter to support an average current and a root mean square (RMS) current. The method further includes sizing the inductor to lose a portion of inductance at a peak current as a result of inherent soft saturation in soft saturated inductors or entering a roll-off region, wherein the roll-off region is situated between a start of inductance saturation and a full inductance saturation in hard saturated inductors.

In an embodiment, the portion of inductance is about 30%.

In an embodiment, a modified peak current mode controller is used to control the power converter in a peak current control mode.

In an embodiment, the power converter is a non-isolated high density power converter.

In an embodiment, the power converter is a DC-DC boost converter.

In an embodiment, the power converter is a closed loop boost converter.

In an embodiment, the inductor has an unsaturated inductance of 100 uH.

In an embodiment, the inductor has a saturated inductance of 20 uH.

In an embodiment, inductance saturation begins at a saturated current of 20 A.

In an embodiment, the power converter operates in one of: a continuous conduction mode; a discontinuous conduction mode; and a boundary conduction mode.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 depicts a block diagram of an example power converter with a partially saturated inductor, according to an embodiment;

FIG. 2 depicts an example method flow of designing the power converter of FIG. 1, according to an embodiment;

FIG. 3A depicts a schematic of a DC-DC converter, according to an embodiment;

FIG. 3B depicts a schematic of an example DC-DC boost converter; according to an embodiment;

FIG. 4 depicts a graph of inductance versus current, according to an embodiment;

FIG. 5 depicts examples of 2^{nd} order DC-DC converters, according to an embodiment;

FIG. 6 depicts examples of 4^{th} order DC-DC converters, according to an embodiment;

FIG. 7 depicts a graph of a simulation result at saturated current when using a modified peak current mode controller; according to an embodiment; and

FIG. 8 depicts a graph of slope compensation and saturated current for using a modified peak current mode controller and a traditional peak current mode controller, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” should be read as including variation from the nominal value, for example, a +/−10% variation from the nominal value. It is to be understood that such a variation is always included in a given value provided herein, whether or not it is specifically referred to.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to power converters, and more particularly to a power converter which operates the inductor at its average and root mean square (RMS) rating, but at a higher peak current.

In hard saturated inductors, if the peak current exceeds a predetermined threshold (i.e., the knee current), the inductance of such an inductor exponentially decreases to its saturated level. This level can be as low as 10 times lower than its original value. And caused the inductor and the overall converter to overheat.

This overheating will not only cause damage to the inductor, but to the power switches as well. Thus, such a mode of operation is not desirable nor easy to achieve due to the high nonlinearity on the inductor current (moving from a non-saturated region to the saturated region in a single switching period).

Moreover, as the inductance of an inductor varies with its peak current during one or more switching cycle, the dc dc converter may exhibits different types of instability such as small signal instability, large signal instability, and low frequency instability.

As a solution to the problems, techniques disclosed herein relate to sizing the inductor to be able to handle the average and RMS current, while losing about 30% of its inductance at peak current due to entering the roll-off region (between the start of saturation and full saturation). Hence, this results in a partially saturated inductor.

A modified peak current mode controller is proposed to be implemented to be able to control the converter in peak current control mode. The compensator is proposed to provide robustness or wide range of operation of non-isolated DC-DC converters to control partially saturated parallel/interleaved DC-DC converters.

Advantageously, the techniques disclosed herein may be used in a variety of applications requiring power converters of a smaller size. Broadly speaking, the power converters disclosed herein may be applied to both existing technologies, and may help facilitate newer technologies which were previously unachievable due to an inability to reduce the size of a power converter.

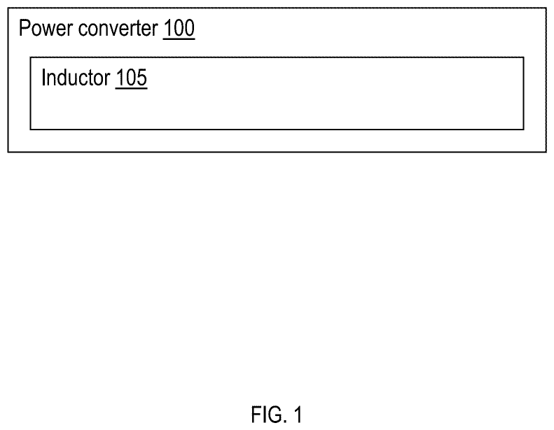

Referring to FIG. 1, depicted therein is an example power converter 100 with a partially saturated inductor, according to an embodiment of the present disclosure. The power converter includes an inductor 105. The inductor 105 is sized to support an average current and a root mean square (RMS) current. The inductor 105 is further sized to lose a portion of inductance at a peak current as a result of entering a roll-off region, wherein the roll-off region is situated between a start of inductance saturation and a full inductance saturation.

The inductor 105 may be sized by considering the loss of a portion of an inductance at a peak current. In soft saturated inductors, such loss has a linear relation ship with the inductor current. In hard saturated inductors, such loss occurs exponentially and it is referred to as the roll-off region, where the roll-off region is situated between a start of inductance saturation and a full inductance saturation.

The inductor 105 loses portion of its inductance when enters the roll-off region. An inductor 105 may enter and exists the roll-off region within one switching cycle or more, depending on the operating conditions, such as, input voltage (Vin), output voltage (Vo), load current (Io), continuous current mode, discontinuous current mode, boundary conduction mode.

For clarity of illustration, only a single inductor 105 is shown, but it will be appreciated that the power converter 100 may include any number of inductors 105, e.g., a plurality of inductors 105.

In an embodiment, the portion of inductance is about 30%.

In an embodiment, a modified peak current mode controller is used to control the power converter 100 in a peak current control mode with soft saturated inductor, partially saturated inductor, or fully saturated inductor.

The power converter maybe operated in continuous current mode, discontinuous current mode, or boundary conduction mode.

The modified peak current mode controller provides robustness or a wide range of operation of non-isolated DC-DC converters to control partially saturated parallel/interleaved DC-DC converters.

In an embodiment, the power converter is a non-isolated high density power converter.

Benefits of the present disclosure include allowing for several new applications of power converters, as they may be used in circumstances requiring power converters of a smaller size. Moreover, the power convertors disclosed herein improve the range of load operations.

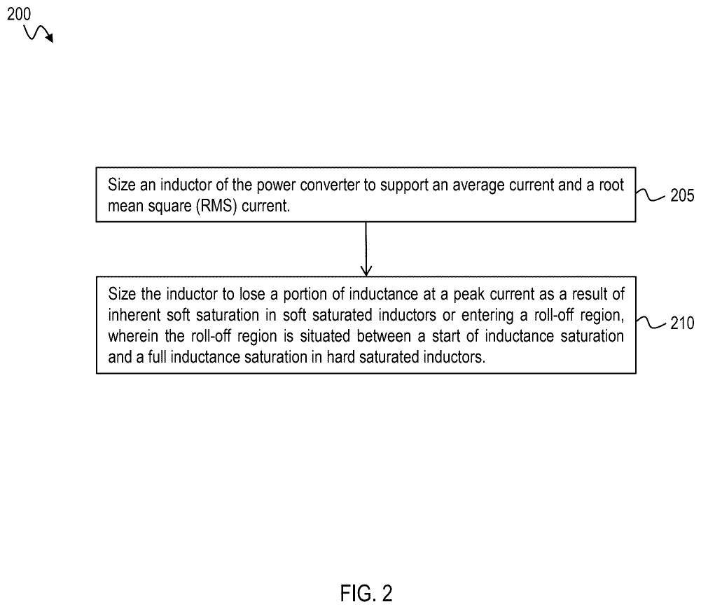

Referring now to FIG. 2, depicted therein is a method 200 of designing a power converter with a partially saturated inductor, according to an embodiment of the present disclosure. The method 200 includes sizing an inductor of the power converter to support an average current and a root mean square (RMS) current. The method 200 further includes sizing the inductor to lose a portion of inductance at a peak current as a result of inherent soft saturation in soft saturated inductors or entering a roll-off region, wherein the roll-off region is situated between a start of inductance saturation and a full inductance saturation in hard saturated inductors.

It can be also used to improve the stability of soft saturated inductors.

The inductor loses portion of its inductance when enters the roll-off region. An inductor may enter and exists the roll-off region within one switching cycle or more, depending on the operating conditions, such as, input voltage (Vin), output voltage (Vo), load current (Io), continuous current mode, discontinuous current mode, boundary conduction mode.

In an embodiment, the portion of inductance is about 30%.

In an embodiment, a modified peak current mode controller is used to control the power converter in a peak current control mode.

The modified peak current mode controller provides robustness or a wide range of operation of non-isolated DC-DC converters to control partially saturated parallel/interleaved DC-DC converters.

In an embodiment, the power converter is a non-isolated high density power converter.

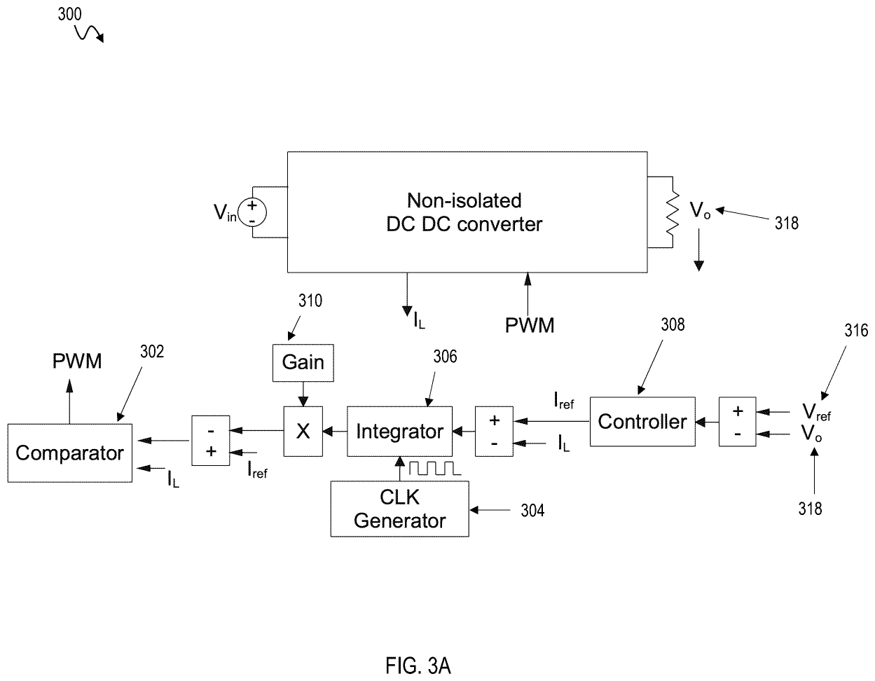

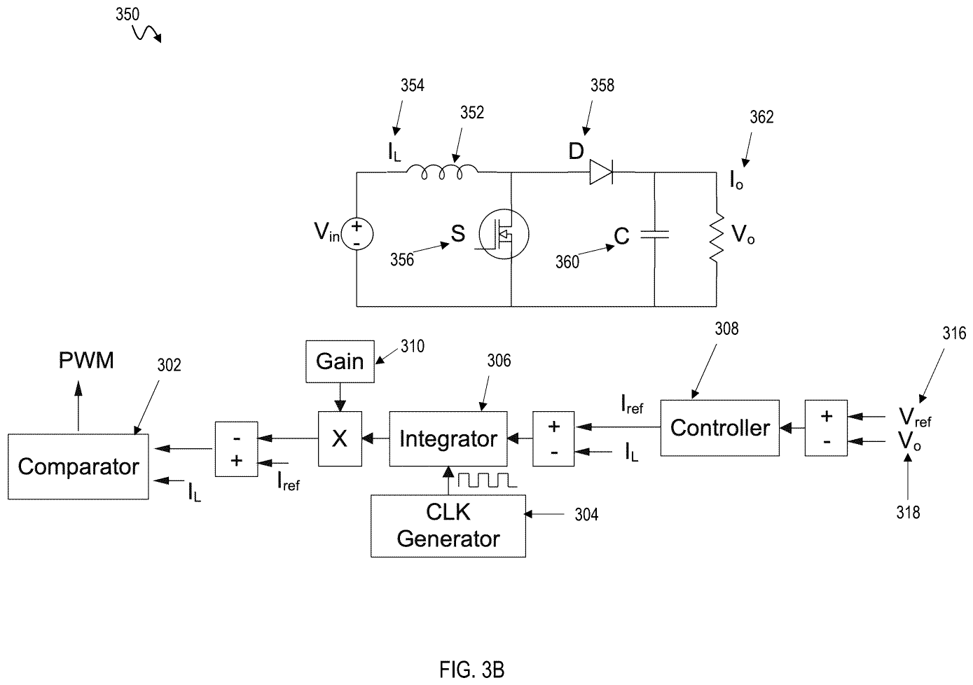

Referring now to FIG. 3A, depicted therein is a schematic of DC-DC converter 300, according to an embodiment of the present disclosure.

In an embodiment, the DC-DC converter 300 includes comparator 302.

In an embodiment, the DC-DC converter 300 includes clock generator 304.

In an embodiment, the DC-DC converter 300 includes an integrator 306.

In an embodiment, the DC-DC converter 300 includes a controller 308.

In an embodiment, the DC-DC converter 300 includes gain 310.

In an embodiment, the DC-DC converter 300 includes a load 312.

In an embodiment, the DC-DC converter 300 includes input voltage (VN) 312.

The DC-DC boost converter 300 also depicts an initial instantaneous current (Vret) 316 and an initial instantaneous voltage (Vo) 318.

In an embodiment, a modified peak current mode (MPCM) controller is applied to the DC-DC converter 300.

In an embodiment, the application is to examine statbility under a saturated inductor.

In an embodiment, the the DC-DC converter 300 is a 2^{nd} order non-isolated converter.

In an embodiment, the the DC-DC converter 300 is a 4^{th} order non-isolated converter.

In an embodiment, the the DC-DC converter 300 is a buck converter.

In an embodiment, the the DC-DC converter 300 is a boost converter.

In an embodiment, the the DC-DC converter 300 is a buck-boost converter.

In an embodiment, the DC-DC converter 300 operates in at least one of: a continuous conduction mode; a discontinuous conduction mode; and a boundary conduction mode.

FIG. 3B, depicted therein is a schematic of DC-DC boost converter 350, according to an embodiment of the present disclosure.

In an embodiment, the DC-DC boost converter 350 includes an inductor (I_{L}) 352.

In an embodiment, the DC-DC boost converter 350 includes an inductor current (I_{L}) 354.

In an embodiment, the DC-DC boost converter 350 includes a switch (S) 356.

In an embodiment, the DC-DC boost converter 350 includes diode (D) 358.

In an embodiment, the DC-DC boost converter 300 includes a capacitor (C) 360.

In an embodiment, the DC-DC boost converter 300 includes a load 312.

The DC-DC boost converter 350 also depicts an initial instantaneous current (I₀) 362.

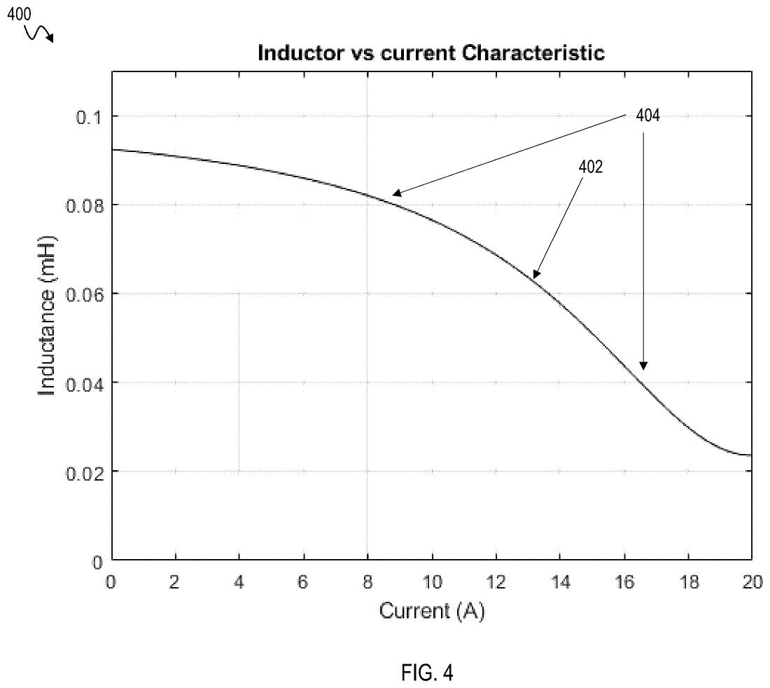

FIG. 4 depicts a graph 400 of inductance versus current (curve 402), according to an embodiment of the present disclosure.

The inductance versus current curve 402 may be based on the following equations:

$$L = {L}_{deepsat} + \frac{{L}_{nom} - {L}_{deepsat}}{2} ( 1 - \frac{2}{π} {tan}^{- 1} ( σ ( {i}_{L} - {I}_{L}^{*} ) ) )$$

$$Where :$$

$${I}_{L}^{*} = \frac{{I}_{70} cot ( {πΓ}_{30} ) - {I}_{30} cot ( {πΓ}_{70} )}{cot ( {πΓ}_{30} ) - cot ( {πΓ}_{70} )}$$

$${Γ}_{30} = \frac{{L}_{30} - {L}_{deepsat}}{{L}_{nom} - {L}_{deepsat}}$$

$${Γ}_{30} = \frac{{L}_{70} - {L}_{deepsat}}{{L}_{nom} - {L}_{deepsat}}$$

$$σ = \frac{cot ( {πΓ}_{30} ) - cot ( {πΓ}_{70} )}{{I}_{30} - {I}_{70}}$$

Γ₃₀, Γ₇₀ are inductor dependent parameters
Lₙₒᵣₘ is the nominal inductance value of the given inductor
L_{Deepsat} is the saturated inductance value of the given inductor

Roll-off region 404 is also depicted in the graph 400.

In an embodiment, an inductor 302 has an unsaturated inductance of 100 uH.

In an embodiment, the inductor 302 has a saturated inductance (Lₛ) of 20 uH.

In an embodiment, the saturation begins at a saturated current (Iₛ) of 20A.

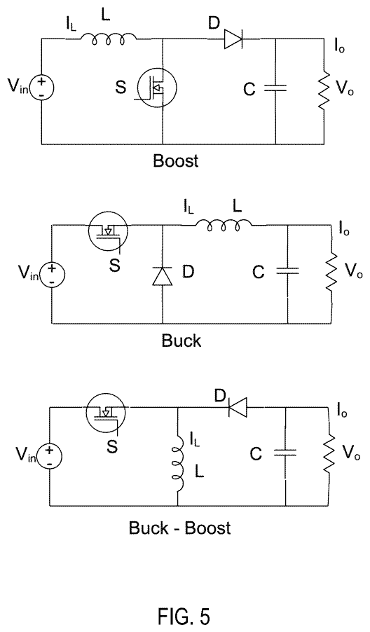

Referring now to FIG. 5, shown therein are examples of 2^{nd} order DC-DC boost converters, according to an embodiment of the present disclosure.

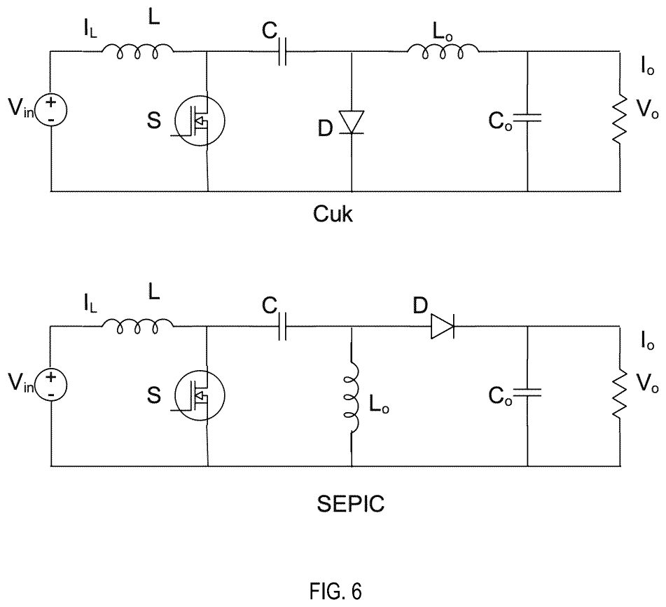

Referring now to FIG. 6, shown therein are examples of 4^{th} order DC-DC boost converters, according to an embodiment of the present disclosure.

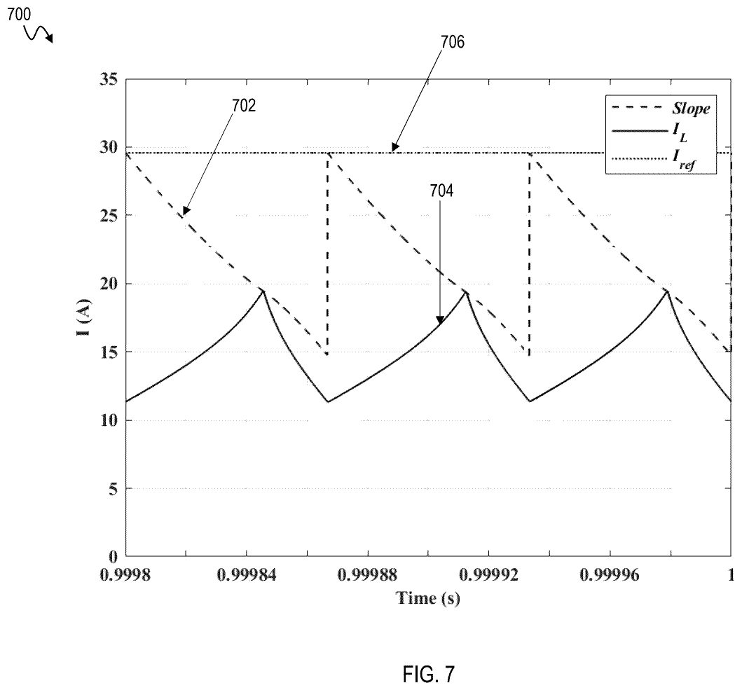

Referring now to FIG. 7, shown therein is a graph 700 of a simulation result at saturated current when using MPCM, according to an embodiment of the present disclosure.

The graph 700 depicts a slope 702, an inductance current (I_{L}) 704, and a reference current (I_{ref}) 706.

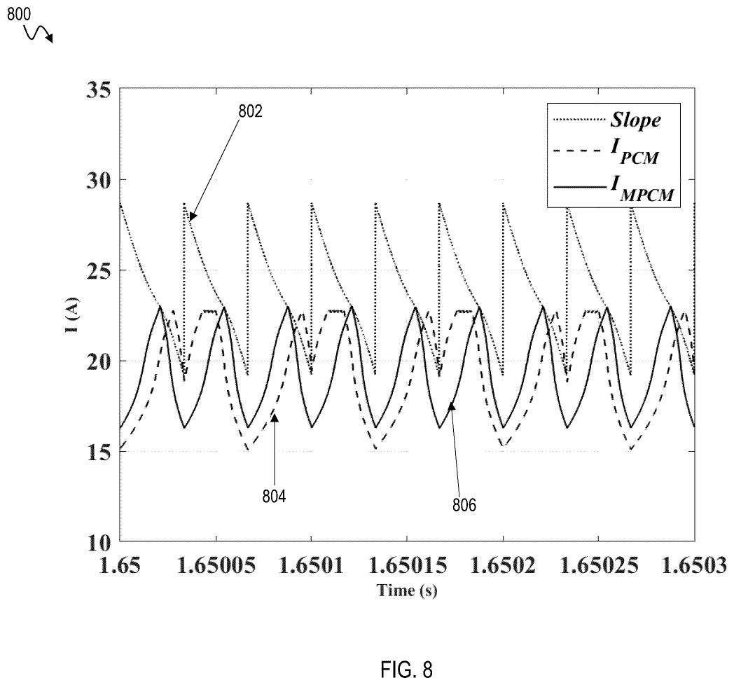

Referring now to FIG. 8, shown therein is a graph 800 of slope compensation and saturated current for using MPCM controller and traditional PCM controller, according to an embodiment of the present disclosure. The traditional PCM results in disturted inductor current which will lead to converter instability and damage, where the MPCM maintained uniform current switching under the same operating condition.

The graph 800 depicts a slope 802, an PCM current (I_{PCM}) 804, and a MPCM current (I_{MPCM}) 806.

In an embodiment, a comparison between a PCM controller and MPCM controller is used to examine stability when a converter is operated at a saturated current.

In an embodiment, a subharmonic is observed during saturation where a PCM controller is used.

While the above description provides examples of one or more apparatus, methods, or systems, it will be appreciated that other apparatus, methods, or systems may be within the scope of the claims as interpreted by one of skill in the art. Elements of each embodiment may be incorporated into other embodiments, for example, configurations or components discussed in relation to one embodiment, may be applied to other embodiments disclosed herein. Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present invention.

1. A power converter with a partially saturated inductor, the power converter comprising:
an inductor sized to:
support an average current and a root mean square (RMS) current; and
lose a portion of inductance at a peak current as a result of inherent soft saturation in soft saturated inductors or entering a roll-off region, wherein the roll-off region is situated between a start of inductance saturation and a full inductance saturation in hard saturated inductors.

2. The device of claim 1, wherein the portion of inductance is about 30%.

3. The device of claim 1, wherein a modified peak current mode controller is used to control the power converter in a peak current control mode.

4. The device of claim 1, wherein the power converter is a non-isolated high density power converter.

5. The device of claim 1, wherein the power converter is one of: a boost converter; a buck converter; and buck-boost converter; a 2^{nd} order converter; and a 4^{th} order converter.

6. The device of claim 1, wherein the power converter is a open loop boost converter.

7. The device of claim 1, wherein the inductor has an unsaturated inductance of 100 uH.

8. The device of claim 1, wherein the inductor has a saturated inductance of 20 uH.

9. The device of claim 1, wherein inductance saturation begins at a saturated current of 20 A.

10. The device of claim 1, wherein the power converter operates in one of: a continuous conduction mode; a discontinuous conduction mode; and a boundary conduction mode.

11. A method of designing a power converter with a partially saturated inductor, the method comprising:
sizing an inductor of the power converter to support an average current and a root mean square (RMS) current; and
sizing the inductor to lose a portion of inductance at a peak current as a result of inherent soft saturation in soft saturated inductors or entering a roll-off region, wherein the roll-off region is situated between a start of inductance saturation and a full inductance saturation in hard saturated inductors.

12. The method of claim 11, wherein the portion of inductance is about 30%.

13. The method of claim 11, wherein a modified peak current mode controller is used to control the power converter in a peak current control mode.

14. The method of claim 11, wherein the power converter is a non-isolated high density power converter.

15. The method of claim 11, wherein the power converter is one of: a boost converter; a buck converter; and buck-boost converter; a 2^{nd} order converter; and a 4^{th} order converter.

16. The method of claim 11, wherein the power converter is a closed loop boost converter.

17. The method of claim 11, wherein the inductor has an unsaturated inductance of 100 uH.

18. The method of claim 11, wherein the inductor has a saturated inductance of 20 uH.

19. The method of claim 11, wherein inductance saturation begins at a saturated current of 20 A.

20. The method of claim 11, wherein the power converter operates in one of: a continuous conduction mode; a discontinuous conduction mode; and a boundary conduction mode.
